(19) United States
(12) Patent Application Publication
(10) Pub. No.: US 2026/0037403 A1
(43) Pub. Date: Feb. 5, 2026

(54) MACHINE LEARNING-BASED CONTEXT LABELING FOR TOKENIZED LOG MESSAGES

(71) Applicant: Cisco Technology, Inc., San Jose, CA (US)

(72) Inventors: Timothy Simon Stirling, Gilly (CH); Sofia Karygianni, Dübendorf (CH); Abhishek Kumar, Vancouver (CA)

(73) Assignee: Cisco Technology, Inc., San Jose, CA (US)

(21) Appl. No.: 18/790,027

(22) Filed: Jul. 31, 2024

(51) Int. Cl. G06F 11/32; G06F 40/186

(52) U.S. Cl. CPC G06F 11/327; G06F 16/2358; G06F 40/186

(57) ABSTRACT

In one implementation, a device generates a template for a particular parameter in one or more log files. The device uses a language model to determine a context for the particular parameter based on the template that would be relevant to an administrator. The device generates a visualization of the particular parameter based on the context. The device provides the visualization to a user interface for review by the administrator.

### TECHNICAL FIELD

The present disclosure relates generally to machine learning-based context labeling for tokenized log messages.

### BACKGROUND

Log messages are commonly parsed via templating algorithms that separate invariant (static) text from variable text. For instance, in the case of network logs, variable log text may include dynamically-updated sub-strings such as time stamps, key performance indicator values, network addresses and ports, and the like. To this end, log templates are relevant for various purposes such as log compression, modelling state transitions for devices, and visualizing log messages, among others.

However, a limitation of existing templating algorithms is that template algorithms lack contextual information on the parameters, variables, and units that are present in the log message. As a result, there is no straightforward and automatic way in which these parameters and values can be visualized or processed. When recording or displaying a variable, understanding the context is important for choosing the correct type of chart, labelling the chart axis, and processing the data appropriately. For example, system logs (syslogs) reporting high memory usage or high central processing unit (CPU) temperatures might best be displayed as a time series, while other variables like network addresses might best be displayed by a histogram, and others like failure count by an explicit ordering. Indeed, consider the case in which the system sends a high memory usage alert for review by an administrator. In such a case, providing context to the administrator in the form of a chart of memory usage over time, in conjunction with the alert, would allow the administrator to determine the trend and severity. Furthermore, such contextual information could also be leveraged by machine learning (ML) systems to forecast outages, e.g., to predict when critical thresholds for memory usage would be exceeded.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example architecture for machine learning-based context labeling for tokenized log messages;

FIG. 4 illustrates an example visualization of a parameter based on log data; and

FIG. 5 illustrates an example simplified procedure for performing machine learning-based context labeling for tokenized log messages.

### DESCRIPTION OF EXAMPLE IMPLEMENTATIONS

### Overview

According to one or more implementations of the disclosure, a device generates a template for a particular parameter in one or more log files. The device uses a language model to determine a context for the particular parameter based on the template that would be relevant to an administrator. The device generates a visualization of the particular parameter based on the context. The device provides the visualization to a user interface for review by the administrator.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

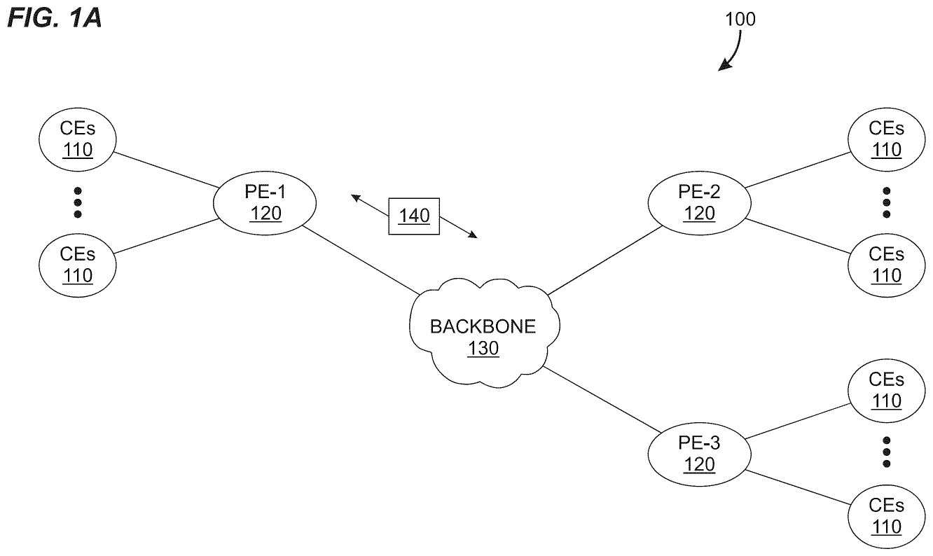

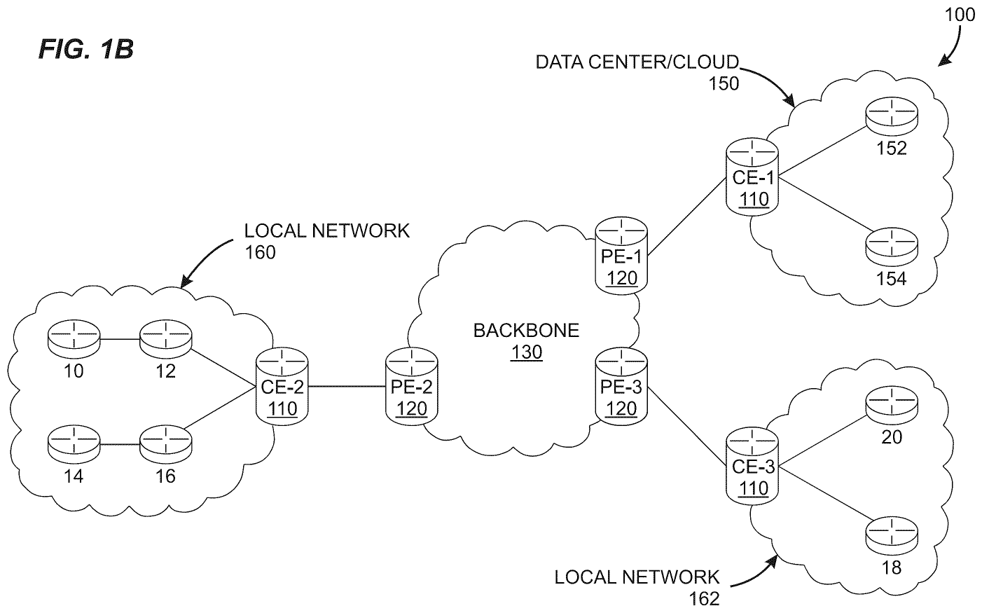

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

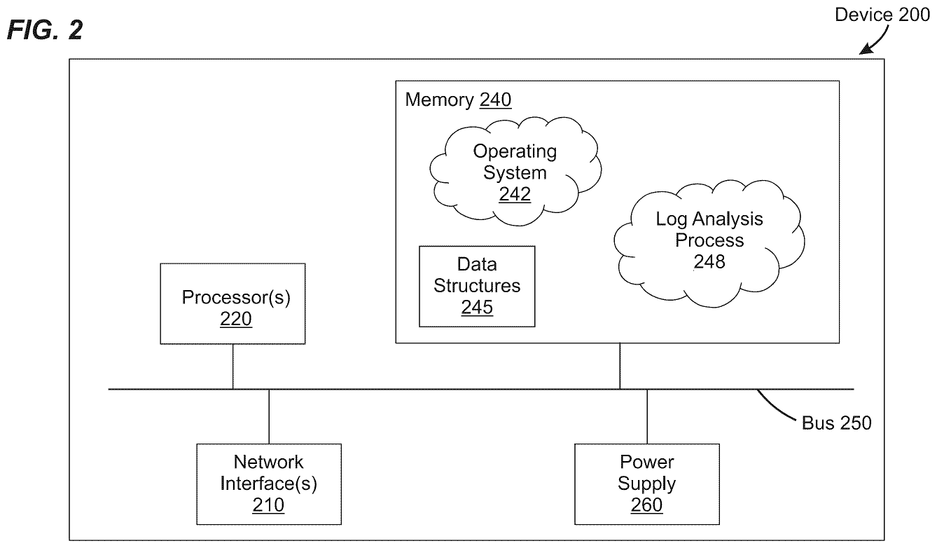

FIG. 2 is a schematic block diagram of an example node/device 200 (e.g., an apparatus) that may be used with one or more implementations described herein, e.g., as any of the computing devices shown in FIGS. 1A-1, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250 and powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a process such as log analysis process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, log analysis process 248 may include computer executable instructions that, when executed by processor(s) 220, cause device 200 to perform the techniques described herein. To do so, in some implementations, log analysis process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, log analysis process 248 may employ one or more supervised, unsupervised, or semi-supervised machine learning models. Generally, supervised learning entails the use of a training set of data, as noted above, that is used to train the model to apply labels to the input data. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that log analysis process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, log analysis process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs), other transformer models, and the like.

As noted above, logs are generated in a wide variety of use cases for purposes of monitoring an underlying system or process. For instance, in the case of a computer network, devices such as routers, switches, access points, gateways, servers, endpoints, and the like, may generate log files (e.g., database entries, messages, stored files, etc.). Such log files can then be used for purposes such as detecting anomalous behaviors in the network, security breaches, network assurance, making routing or other configuration decisions, and the like.

In some implementations, a templating algorithm may parse a log to separate invariant (static) text from variable text. For instance, the variable text in a log may include dynamically updated sub-strings such as time stamps, key performance indicator (KPI) values, network addresses such as IPs and ports, and the like. Log templates are relevant for various uses such as log compression, modelling of state transitions for devices, visualizing log messages, among others.

However, a fundamental limitation of simply relying on log templates is that the template algorithm often lacks contextual information regarding the log parameters, their variables, and their units. As a result, there is no straight-forward and automatic way in which these parameters and their values can be visualized or processed. When recording or displaying a variable, understanding the context is important for choosing the correct type of chart, labelling the chart axis, and processing the data appropriately.

For example, system logs (syslogs) reporting high memory usage or high central processing unit (CPU) temperatures would be best displayed as a time series, while other variables like IP addresses might be best displayed by a histogram, and others like failure count by an explicit ordering. In network syslogs, a device might send high memory usage alerts. However, doing so only alerts an administrator or other user as to the current condition and without providing any context. In such a case, for instance, it may also be valuable to display a chart of the memory usage over time so that the administrator can determine the trend and severity. This context, though, varies by parameter and potentially other factors, as well. Furthermore, this contextual information is desirable because it can be leveraged by machine learning (ML) systems to forecast outages, e.g., to predict when critical thresholds for memory usage would be exceeded.

### Machine Learning-Based Context Labeling for Tokenized Log Messages

The techniques introduced herein allow for the log analysis system to extract automatically contextual information from the log data. In some aspects, the system may then use the extracted contextual information to generate visualizations for the end user, thereby providing a deeper understanding of the context and impact of the log messages.

Illustratively, the techniques described herein may be performed by hardware, software, and/or firmware, such as in accordance with language model process 249, which may include computer executable instructions executed by the processor 220 (or independent processor of interfaces 210) to perform functions relating to the techniques described herein, such as in conjunction with log analysis process 248.

Specifically, according to various embodiments, a device generates a template for a particular parameter in one or more log files. The device uses a language model to determine a context for the particular parameter based on the template that would be relevant to an administrator. The device generates a visualization of the particular parameter based on the context. The device provides the visualization to a user interface for review by the administrator.

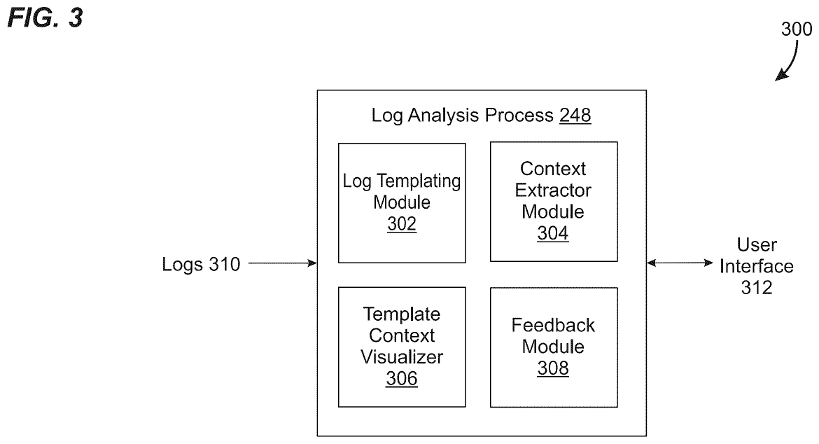

Operationally, FIG. 3 illustrates an example architecture for machine learning-based context labeling for tokenized log messages, according to various implementations. At the core of architecture 300 is log analysis process 248, which may be executed by a device (e.g., a device 200) that either generates logs 310 locally or receives them remotely, such as via a computer network. Log analysis process 248 may also communicate with a user interface 312, which may be local to the device executing log analysis process 248 or another device in communication therewith.

As shown, log analysis process 248 may include any or all of the following components: a log templating module 302, a context extractor module 304, a template context visualizer 306, and/or a feedback module 308. As would be appreciated, the functionalities of these components may be combined or omitted, as desired. In addition, these components may be implemented on a singular device or in a distributed manner, in which case the combination of executing devices can be viewed as their own singular device for purposes of executing log analysis process 248.

During execution, the components of log analysis process 248 may operate in conjunction with one another to implement to augment the templating of logs 310 with automatically extracted contextual information from the log messages. In various implementations, the system generates log templates and variables along with a context for the variables that is derived from the rest of the log message. This information can then be suitably visualized for the end user in a user interface, such as user interface 312, thereby providing the user with deeper understanding around the context and impact of the log messages.

During execution, log templating module 302 may be responsible for parsing logs 310 and extracting its constituent parameters, their values, and their associated templates. For instance, in the context of a network switch, logs 310 may appear similar to:

| | |
|---|---|
| System start time: | Tue Feb 14 13:49:17 2012 |
| System uptime: | 822 days, 20 hours, 2 minutes, 30 seconds |
| . . . | |
| CPU states: | 76.2% user, 23.8% kernel, 0.0% idle |
| Memory usage: | 2073416K total, 1326036K used, 747380K free |
| . . . | |

As can be seen above, the template for each parameter may differ, with each parameter entry including an invariant/static text label, one or more variable fields indicative of its value(s), as well as potentially further text such as punctuation marks to delineate different variables, units of measure, and the like. For instance, in the case of memory usage, the template for the entry may be:

<“Memory Usage:”> <total_memory> <“K”> <“ total”> <“, ”> <used_memory>
<“K”> <“ used”> <“, ”> <free_memory> <“K”> <“ free”>

where fields such as <total_memory>, <used_memory>, and <free_memory> correspond to the values of different memory usage parameters, fields such as <“K”> represent units of measure for those values, fields such as <“total”>, <“used”>, and <“free”> represent textual labels for their corresponding parameters, and fields such as <“,”> represent textual delineators between fields. Of course, different templates could also be used to represent any of the above entries as well. Indeed, log templating module 302 may make use of any number of different log templating algorithms or even a combination of different algorithms, to extract templates for the different parameters found in logs 310.

In various implementations, context extractor module 304 may be responsible for extracting context around the template parameters from logs 310. In one implementation, context extractor module 304 may do so by leveraging a language model, such as an LLM or the like, to analyze the language in the static template text to assign pre-defined labels to the parameters in the template. The labels would be indicative of the parameter's context e.g., ‘temperature’, ‘power’, ‘IP’, ‘count’ etc. As would be appreciated, the language model may be executed by the same device executing log analysis process 248 or context extractor module 304 may access the model remotely.

In some implementations, context extractor module 304 may then link a contextual label extracted from logs 310 to a knowledge graph that provides information as to how the parameters should be processed and visualized for the end user, thereby further enhancing the context for the parameter. In another implementation, the LLM could in turn suggest the optimal processing and visualization of the parameter, based on the learned context. For instance, context extractor module 304 could start with a few pre-defined parameter labels, and then propose new ones along the way if parameters that are not described well by the current labels are encountered. In yet another implementation, the LLM may generate a summary describing the nature and severity of the parameters, based on the learned context. This summary can provide important contextual information to the user. In yet another implementation, the LLM may extract the severity of parameters based on the templates and values and provide this context on high impact parameters to the end user.

Context extractor module 304 may also refine the operation of log templating module 302 by suggesting improvements to finetune its template parsing algorithm(s) based on the nature of the variables involved. Indeed, punctuation or metric units around variables are often not treated properly by templating algorithms and variable context recognition could be used to finetune the templates around the variable instances.

In various implementations, template context visualizer 306 may generate visualizations for presentation by user interface 312 based on the templates, parameters, their values, and their learned contexts. In one implementation, the variables in each template are automatically visualized in user interface 312 based on the assigned visualization configuration and context generated by context extractor module 304. In another implementation, the user can interact with the displayed contexts via user interface 312 to understand how they were derived.

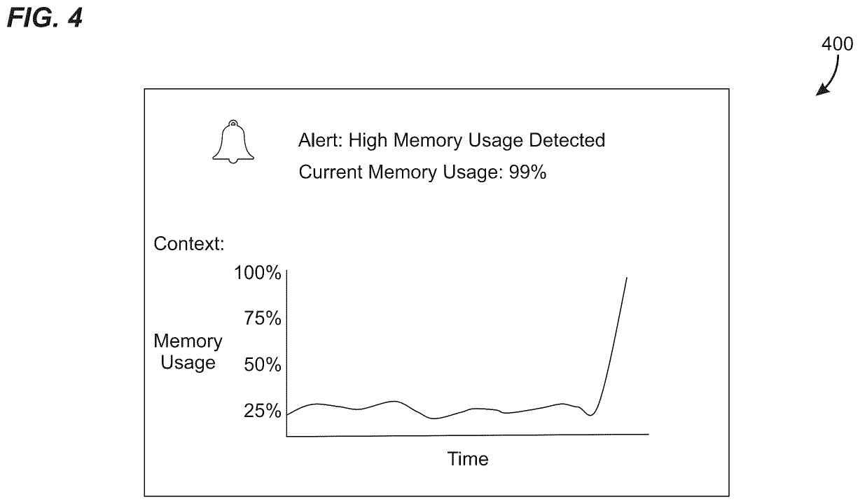

By way of example, FIG. 4 illustrates an example visualization 400 of a parameter based on log data. For instance, consider the case in which one of the parameters in logs 310 indicates the percentage of memory usage by a certain device. In such a case, template context visualizer 306 may determine that the value of that parameter exceeds an acceptable threshold (e.g., 95%) and that it should provide an alert to user interface 312. To complement this alert, template context visualizer 306 may also include additional contextual information, such as a timeseries plot of the memory usage over time. Such information may provide valuable insight to the administrator as to the behavior of the device over time, allowing them to better understand the underlying issue.

Here, the LLM of context extractor module 304 may determine which context should be visualized in conjunction with the parameter based on the documents on which it was trained and/or using a retrieval augmented generation (RAG) mechanism with such documents. For instance, say a troubleshooting guide indicates that an administrator should first look the history of memory usage. If, for instance, the memory usage progressively increases over time, this may indicate a memory leak of a program executed by the device. However, if the memory usage suddenly spikes, this may indicate another underlying problem. Based on this information, the LLM may determine that the most suitable contextual information for the memory usage alert would be to provide a timeseries plot of historical values of the memory usage parameter.

In some implementations, the contextual information may even take the form of other parameters that are associated with a given parameter. For instance, say that there is often a causal link between the traffic load of a router and its memory usage. In such a case, the LLM may decide that a visualization presenting the memory usage should also include some contextual information regarding the traffic load, as well.

Referring again to FIG. 3, feedback module 308 may be responsible for directing user feedback from user interface 312 back to context extractor module 304. For instance, such feedback may take the form of numerical ratings or free-form text with respect to the visualizations generated by template context visualizer 306. In one implementation, this additional feedback data could be used to fine-tune the LLM and improve context learning. For instance, if the user dislikes a given visualization and provides feedback that it should include a timeseries spanning a greater amount of time, context extractor module 304 may learn from this and update the context for the parameter, accordingly.

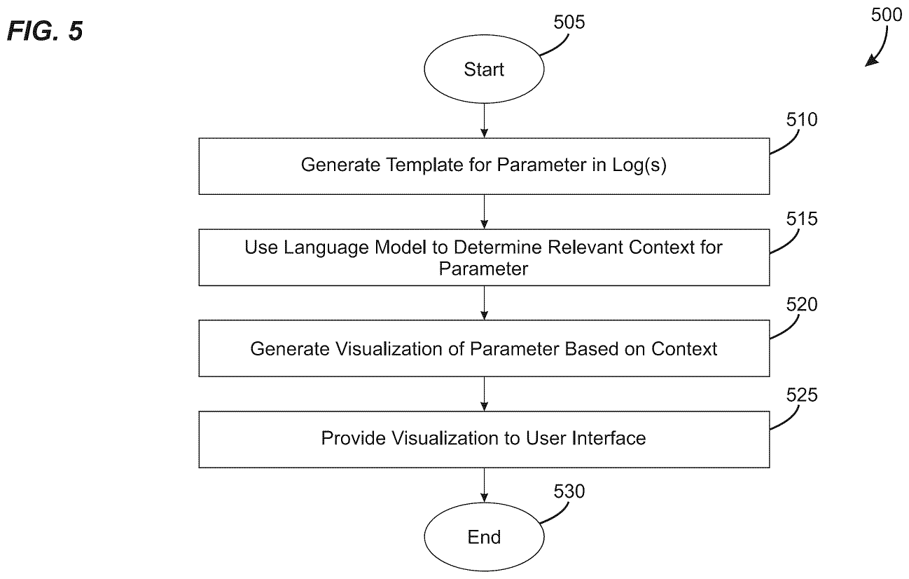

FIG. 5 illustrates an example simplified procedure 500 (e.g., a method) for machine learning-based context labeling for tokenized log messages, in accordance with one or more implementations described herein. For example, a non-generic, specifically configured device (e.g., device 200), such as a router, firewall, controller for a network, endpoint, server, or the like, may perform procedure 500 by executing stored instructions (e.g., log analysis process 248). The procedure 500 may start at step 505, and continues to step 510, where, as described in greater detail above, the device may generate a template for a particular parameter in one or more log files. In some instances, the one or more log files is generated by a router, switch, access point, or gateway of a computer network. In one implementation, the template indicates a value field for the particular parameter in the one or more log files.

At step 515, as detailed above, the device may use a language model to determine a context for the particular parameter based on the template that would be relevant to an administrator. In one implementation, the language model comprises a large language model (LLM). In a further implementation, the context indicates additional information that should be presented in conjunction with the particular parameter. For instance, the context may further indicate whether the additional information should be presented as at least one of: a timeseries, a histogram, or an ordered list. In some implementations, the language model determines the context based in part on a label for the particular parameter indicated by the template. In one implementation, the context comprises a textual summary regarding the particular parameter.

At step 520, the device may generate a visualization of the particular parameter based on the context, as described in greater detail above. In some instances, the visualization comprises an alert regarding the particular parameter.

At step 525, as detailed above, the device may provide the visualization to a user interface for review by the administrator. In some implementation, the device may also provide the template to the user interface for review.

Procedure 500 then ends at step 530.

While there have been shown and described illustrative implementations that provide for machine learning-based context labeling for tokenized log messages, it is to be understood that various other adaptations and modifications may be made within the spirit and scope of the implementations herein. For example, while certain implementations are described herein with respect to using certain models for purposes of making API calls, the techniques herein are not limited as such and can be used for purposes of managing the credentials associated with any task performed via a chatbot, such as executing a command line interface (CLI) command, logging into a remote system, or the like. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
generating, by a device, a template for a particular parameter in one or more log files;
using, by the device, a language model to determine a context for the particular parameter based on the template that would be relevant to an administrator;
generating, by the device, a visualization of the particular parameter based on the context; and
providing, by the device, the visualization to a user interface for review by the administrator.

2. The method as in claim 1, wherein the template indicates a value field for the particular parameter in the one or more log files.

3. The method as in claim 1, wherein the language model comprises a large language model (LLM).

4. The method as in claim 1, wherein the visualization comprises an alert regarding the particular parameter.

5. The method as in claim 1, wherein the context indicates additional information that should be presented in conjunction with the particular parameter.

6. The method as in claim 5, wherein the context further indicates whether the additional information should be presented as at least one of: a timeseries, a histogram, or an ordered list.

7. The method as in claim 1, further comprising:
providing the template to the user interface for review.

8. The method as in claim 1, wherein the language model determines the context based in part on a label for the particular parameter indicated by the template.

9. The method as in claim 1, wherein the context comprises a textual summary regarding the particular parameter.

10. The method as in claim 1, wherein the one or more log files is generated by a router, switch, access point, or gateway of a computer network.

11. An apparatus, comprising:
one or more network interfaces;
a processor coupled to the one or more network interfaces and configured to execute one or more processes; and
a memory configured to store a process that is executable by the processor, the process when executed configured to:
generate a template for a particular parameter in one or more log files;
use a language model to determine a context for the particular parameter based on the template that would be relevant to an administrator;
generate a visualization of the particular parameter based on the context; and
provide the visualization to a user interface for review by the administrator.

12. The apparatus as in claim 11, wherein the template indicates a value field for the particular parameter in the one or more log files.

13. The apparatus as in claim 11, wherein the language model comprises a large language model (LLM).

14. The apparatus as in claim 11, wherein the visualization comprises an alert regarding the particular parameter.

15. The apparatus as in claim 11, wherein the context indicates additional information that should be presented in conjunction with the particular parameter.

16. The apparatus as in claim 15, wherein the context further indicates whether the additional information should be presented as at least one of: a timeseries, a histogram, or an ordered list.

17. The apparatus as in claim 11, wherein the process when executed is further configured to:
provide the template to the user interface for review.

18. The apparatus as in claim 11, wherein the language model determines the context based in part on a label for the particular parameter indicated by the template.

19. The method as in claim 1, wherein the context comprises a textual summary regarding the particular parameter.

20. A tangible, non-transitory, computer-readable medium storing program instructions that cause a device to execute a process comprising:
generating, by the device, a template for a particular parameter in one or more log files;
using, by the device, a language model to determine a context for the particular parameter based on the template that would be relevant to an administrator;
generating, by the device, a visualization of the particular parameter based on the context; and
providing, by the device, the visualization to a user interface for review by the administrator.
